(19) United States
(12) Patent Application Publication
(10) Pub. No.: US 2006/0031361 A1
(43) Pub. Date: Feb. 9, 2006

(54) Method and apparatus for conversational annotation for instant messaging systems

(75) Inventors: Thomas Jack Geraint Bailey, Southampton (GB); Christopher David Paul Jenkins, Southampton (GB); Jonathan Mark Roberts, Southampton (GB); Kieran Paul Scott, Southampton (GB)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, ARMONK, NY (US)

(21) Appl. No.: 11/168,650

(22) Filed: Jun. 28, 2005

(30) Foreign Application Priority Data
Jul. 1, 2004 (GB) 0414716.1

(51) Int. Cl. G06F 15/16; G06F 17/30

(52) U.S. Cl. 709/206; 707/200

(57) ABSTRACT

This invention relates to a method, apparatus, or computer program for conversation annotation for instant messaging systems. The instant messaging method comprises: providing a graphical user interface; determining a selection of two or more existing messages; creating, on an instruction from the GUI, a relationship between the selected messages; and indicating, using links or edges on between the messages, the relationship between the messages. All related messages may be selected with a single selection and printed, stored, or deleted as a batch.

### BACKGROUND OF THE INVENTION

This invention pertains to computers, computer software and other information technology systems and methods and, more particularly, to such systems and methods for instant messaging.

An instant messaging system allows text based real time conversation over a network between user computers. Such a system comprises a server application running on a server computer with client applications running on user computers. The client applications allow connected users to participate in a conversation or chat with each other using graphical user interfaces (GUI).

In a known instant messaging system, a user computer activates a client application (client); the client connects to a server application (server) to notify it that the user is active. The client is presented with a list of other clients that are active and is able to instigate a chat with one or more selected clients. A chat is represented by a chat object and visualized by the GUI. After the chat is set up, each client involved in the chat displays a time ordered list of messages in the GUI. To begin with, the list of messages will be empty, but users within the chat are able to add a message to the message list using their client, which will be placed at the end of the current list of messages on all the clients. This allows a conversation to develop through statements, questions and answers.

Current instant messaging systems offer a linear conversation ordered by time; that is, the messages within a conversation have no reference to other messages within the same conversation. This can give rise to ambiguity within a conversation when messages from two different topics become intertwined. If questions from two different topics are asked at the same time, then an answer to one of the topics needs to explicitly reference the question or topic so that the ambiguity is avoided. In a face-to-face conversation between a group of people, if a person is asked questions by two different people, the person can avoid ambiguity about which question they are answering simply by facing the person to whom the answer is addressed. This creates a reference between the answer being given and the question that was asked.

This problem does not exist in Internet news group message postings where one defines the hierarchical node in the message database at the same time as posting a message. When one posts a message in an Internet news group, one can either reply to an existing message or start a new thread. In the former case, a parent-child relationship is formed between the question and the answer. This relationship is displayed graphically by many news group reader applications (e.g. Mozilla Mail, Microsoft Outlook Express).

However, real time chat is advantageous because it has no apparent structure and messages can be quickly entered. Once a message has been placed in a real time chat, it is displayed as the next message in the time ordered sequence of messages.

For example, in FIG. 1, a conversation is started between Client1, Client2 and Client3 in which two questions are asked. Given that Client3 is also in the conversation, Client3 would need to reference the original question in the answer. For instance “Yes, I am ready for lunch” or “Yes, I would like to eat in the canteen” would avoid an ambiguity arising from a simple “Yes” answer. Since the messages do not hold references to each other in a realtime chat, there is no way for Client3 to reply “Yes” and specify that the answer refers to the first or second question (or topic). Also, consider the situation in which Client2 and Client3 type their answers simultaneously and then Client3 hits the ENTER key so soon after Client2 that Client3 has no time to react.

### SUMMARY OF INVENTION

The user is presented with an interface to create a reference from one message to another message. Then, when an answer is ambiguous, for instance, answering “Yes” in the example above, the user can show the question that the answer refers to.

For this framework, each message is required to have a reference that is unique within the chat. This can be in the form of a special “unique identity” attribute, or a combination of other attributes that together are unique. The model also specifies that each message is represented by an object. A ChatMessage is an object comprising: text; formatting; and unique ID for a particular message.

A new class of objects can be created that exists within this new framework to allow a user to reference one message from another. Comparing a conversation with a graph data structure, then the messages within a conversation can be likened to the nodes of the graph. The references between the messages are then edges in the graph; see FIG. 2. Hence, if a user wants to reference a message from another message, then they can draw an edge between the two messages; see FIG. 3. An Edge is a software object representation of the edge.

The client comprises means for creating an Edge and for notifying all other clients of the creation of the Edge. The Edge comprises the ID of each of the messages that it references and each client uses this information to display the edge. The edge could be displayed in a number of ways; for example, an arrow could be drawn from one message to the other to denote the reference as in FIG. 3.

A user would wish to create an Edge when both of the messages that are to be connected have already been sent and are displayed on each user's GUI. The user wishing to create the Edge would then be able to use the client GUI to specify the messages to connect. The way to achieve this would be client specific, but one possible solution would be to allow the user to drag one message onto another to specify the messages to connect through an edge. The client would then create an Edge and send the Edge to all the other clients.

In the preferred instant messaging system, an Edge only contains references to two messages. It would be possible to adapt the model such that an Edge could contain references to more than two messages, for example, if a user wishes to link three or more messages together using one Edge. However, any advantage of this adapted system can be achieved by creating multiple Edges. For example, if the user wishes to link three messages, message1, message2 and message3, then the adapted model could create an Edge that references message1, message2 and message3. The same can be achieved in our proposed model by creating an Edge from message1 to message2, and an Edge from message2 to message3. In this situation message1 would reference message3 indirectly via message2, and vice versa (see FIG. 4 and FIG. 5).

In one embodiment of the instant messaging system, the Edges would have no direction. In this case, both messages reference each other. Since the messages are in time order, there should be no ambiguity from having a simple Edge between messages. Referring back to FIG. 3, there is no misunderstanding created if the Edge between User1's question and User3's response is undirected or directed. There is, however, an advantage to allowing Edges to be directed. In the case of undirected Edge in FIG. 2, there is no way to specify that message3 references message1 without specifying as well that message1 references message3. Using Edges that have direction allows a distinction and in FIG. 5, message1 can be defined as referencing message3 with an Edge directed towards message3 whereas message3 does not reference message1.

The combination of undirected Edges, directed Edges and indirect references gives rise to new options. In one example a user can select one message (the originating message) or a combination of messages including:
1. all messages that are referenced from the originating message through a directed Edge;
2. all messages that reference the originating message through a directed Edge;
3. all messages that are linked to the originating message from an undirected Edge;
4. all referenced messages (1 and 3 above); and
5. all messages (1, 2 and 3 above).

For example, in the conversation illustrated in FIG. 6, Client3 answers “Yes” and then creates undirected Edges from both of the questions to the answer, indicating that ‘yes’ answers both questions. Since the Edges are not directed, then the first question and the second question reference each other. FIG. 1 shows a conversation window with undirected edges and no messages are selected (all messages are in plain text). Therefore, should the user wish to highlight all messages relating to the Client2's message “Yes, but shall we eat at the canteen today?” then the question “Hi, are you all ready for lunch?” will be selected as well as the “Yes” answer.

FIG. 7 shows a conversation window with undirected Edges and with Client1 and Client3's messages selected (highlighted in italic). Client1's message is indirectly referenced from Client2's message and Client3 is directly referenced.

In the case where Edges have direction (as shown in FIG. 8) and the same client wishes to highlight all messages directly referencing Client2's message, then only the “Yes” answer of Client3 is selected (highlighted in italic).

Therefore, the model allows directed Edges to connect two messages within an instant messaging conversation after messages have been transmitted. In addition, this model can be used to allow additional functions related to linked message, such as performing functions on all messages referencing an originating message. Also, the proposed model allows the user to create an Edge and a message at the same time by specifying the pre-existing message that a new message is replying to at the time of creation of a new message.

### BRIEF DESCRIPTION OF DRAWINGS

In order to promote a fuller understanding of this and other aspects of the present invention, an embodiment of the invention will now be described, by means of example only, with reference to the accompanying drawings in which:

FIG. 1 is an example start of a simple conversation in a instant messaging system;

FIG. 2 is a conversation represented as a graph and linked by an undirected edge;

FIG. 3 is an example of two messages linked by a directed edge represented as an arrow;

FIG. 4 shows undirected edges on a graph;

FIG. 52 shows two directed edges on a graph with the implied indirect reference superimposed;

FIG. 63 shows a conversation window with undirected edges and where no related messages are selected (all messages are in plain text);

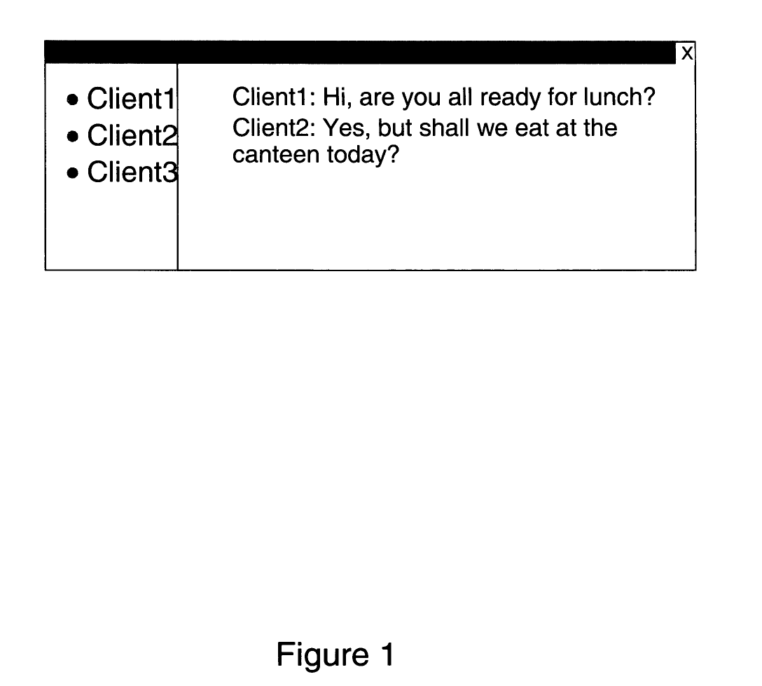

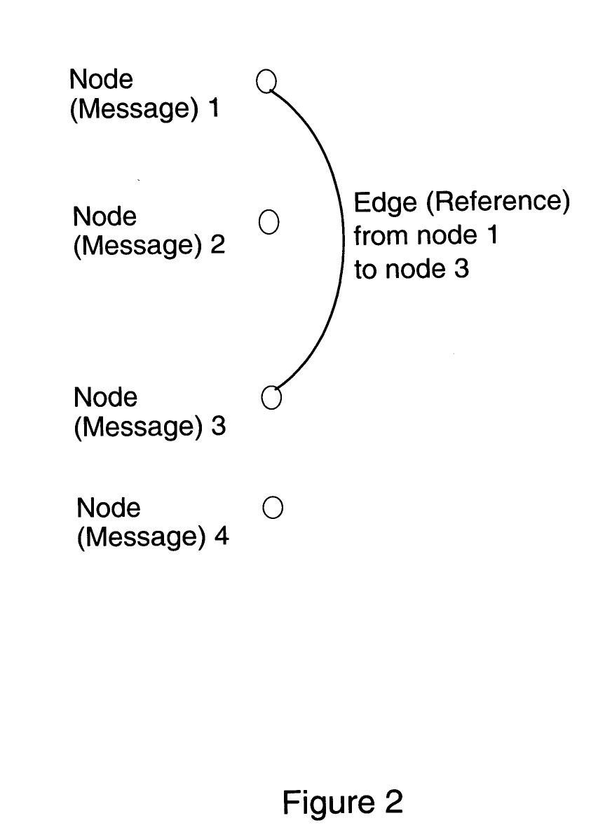

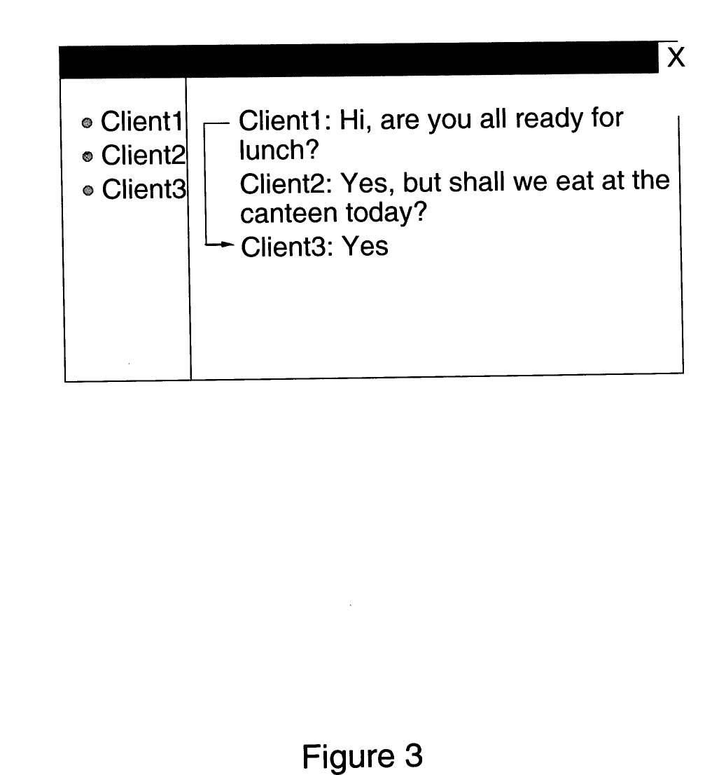

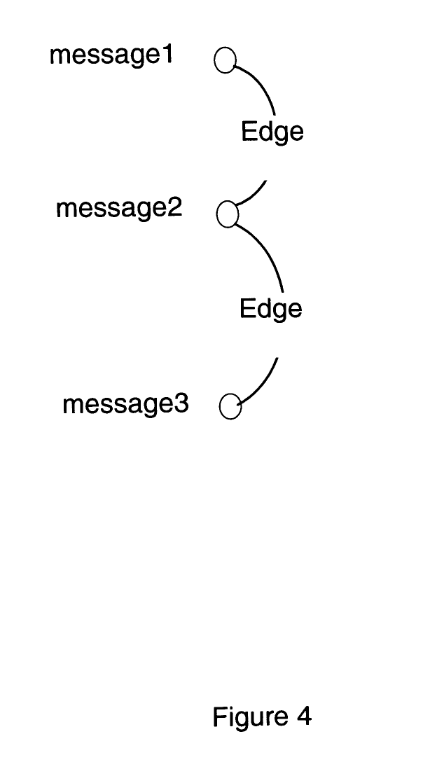

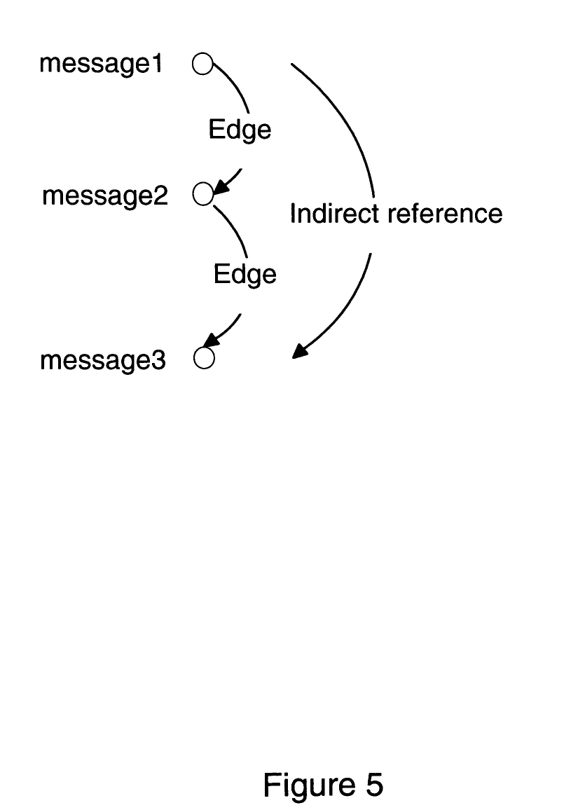

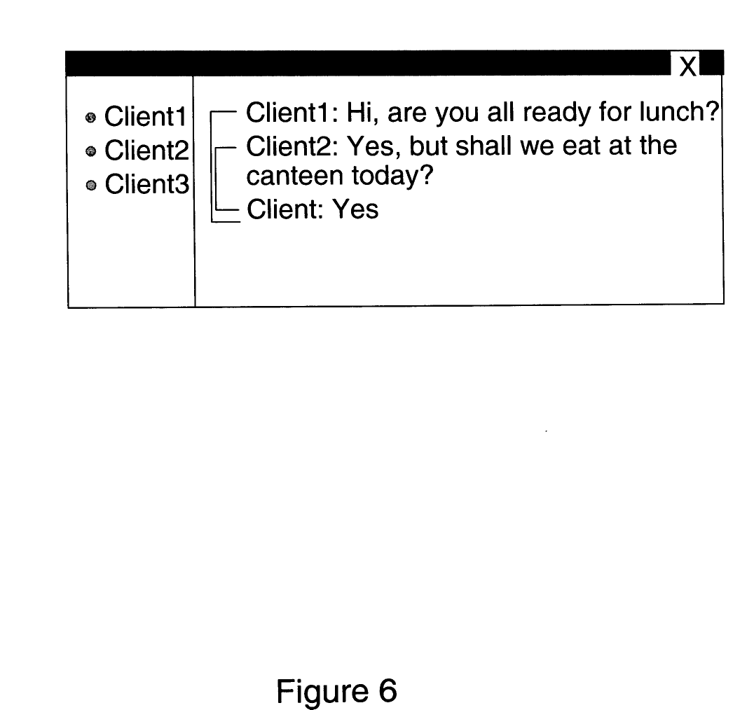

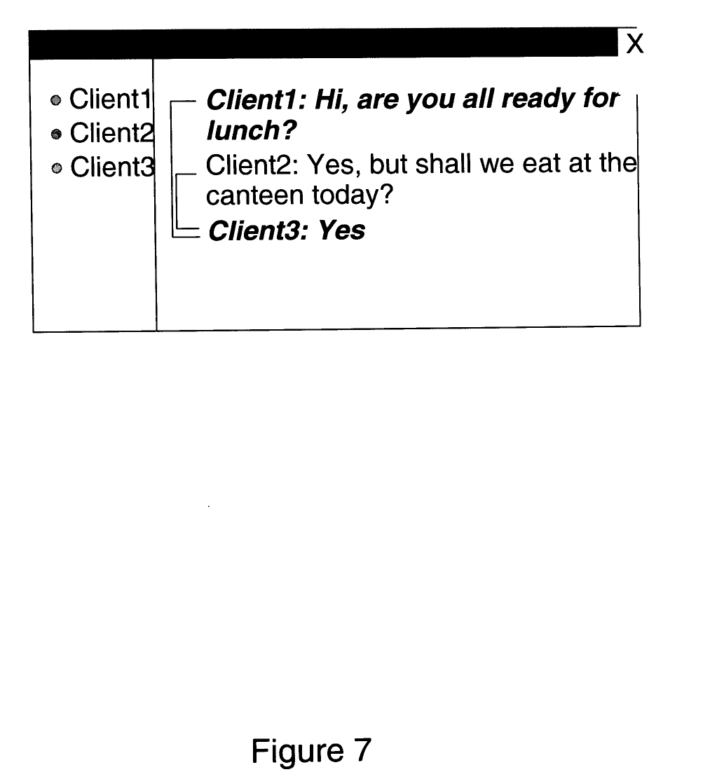

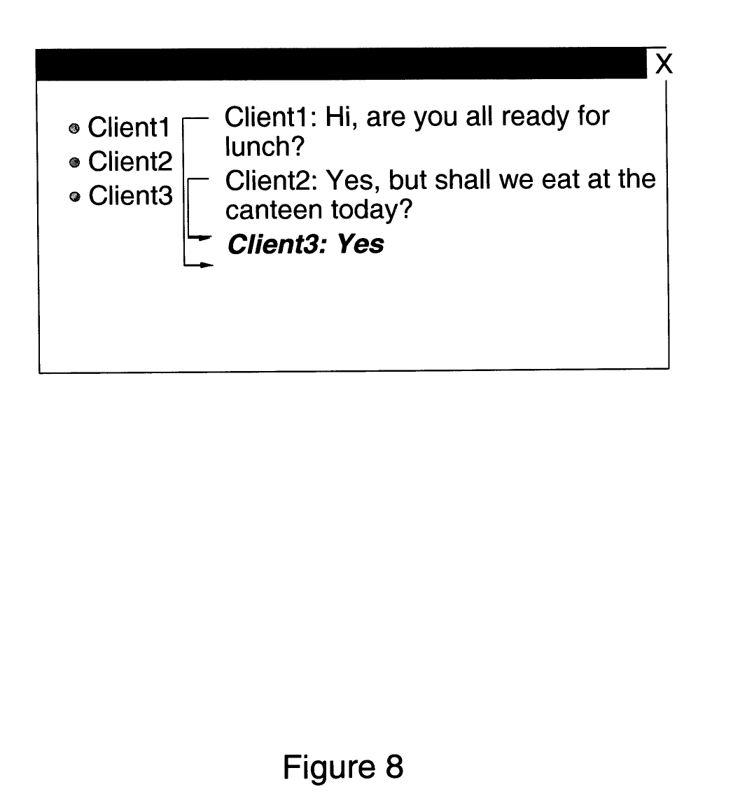

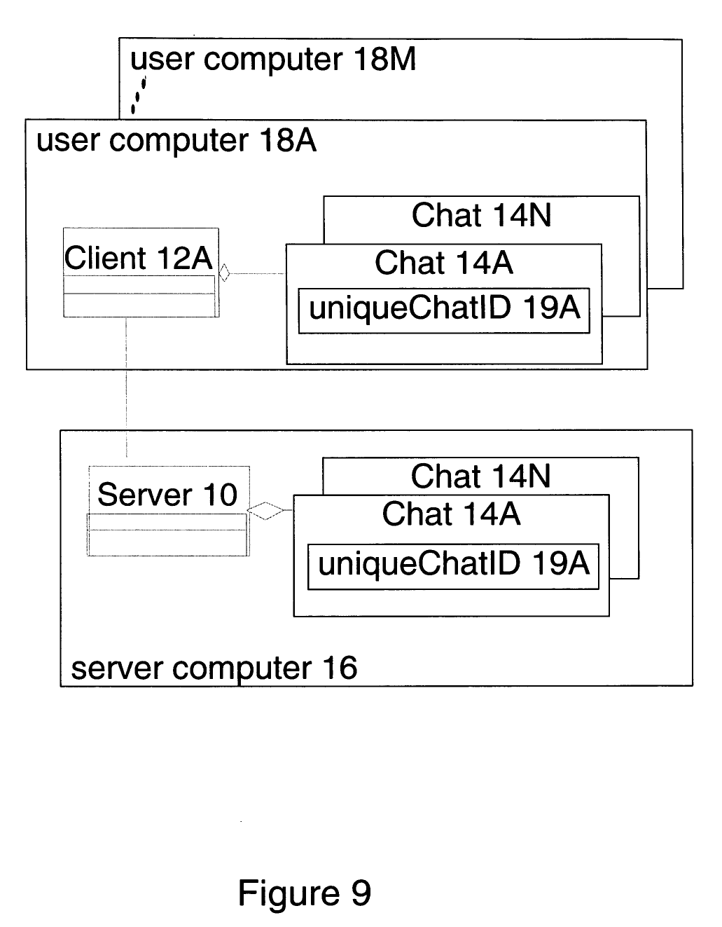

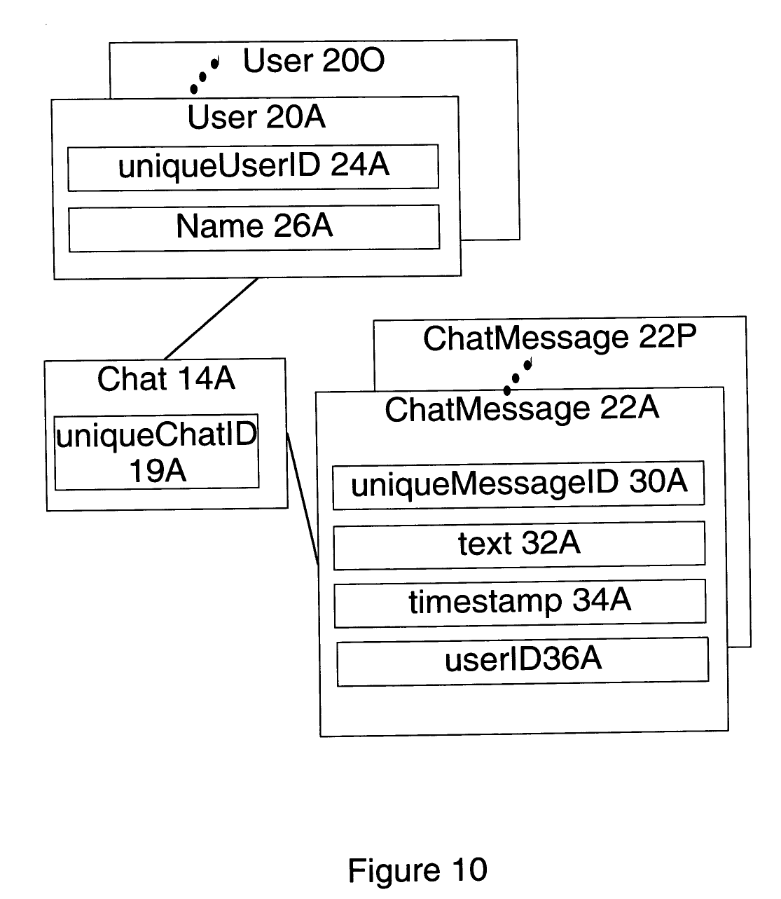

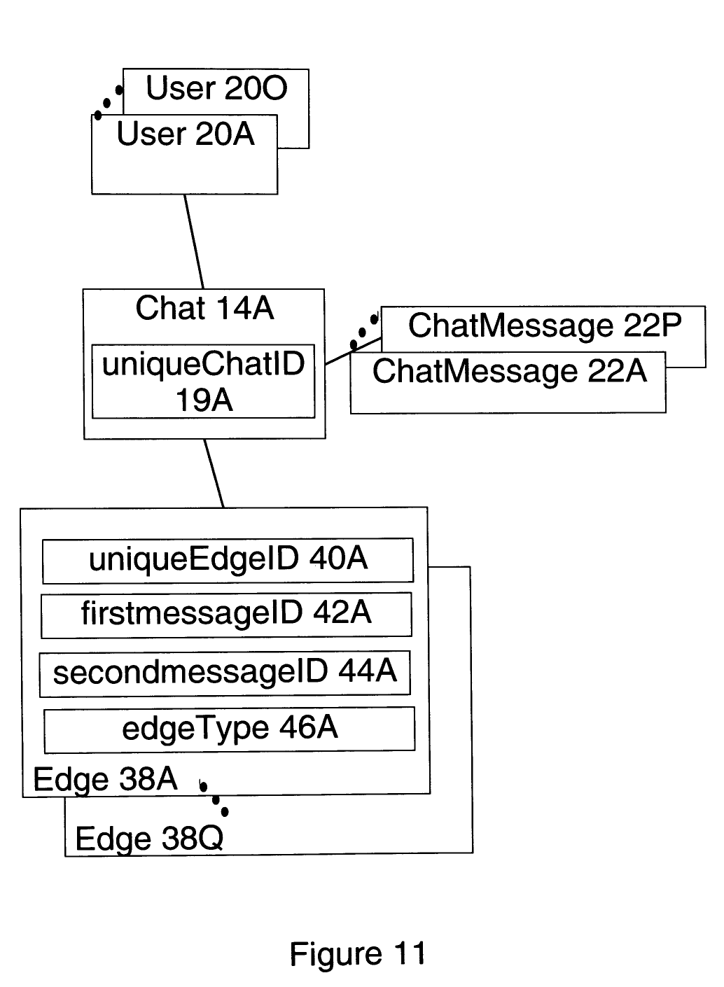

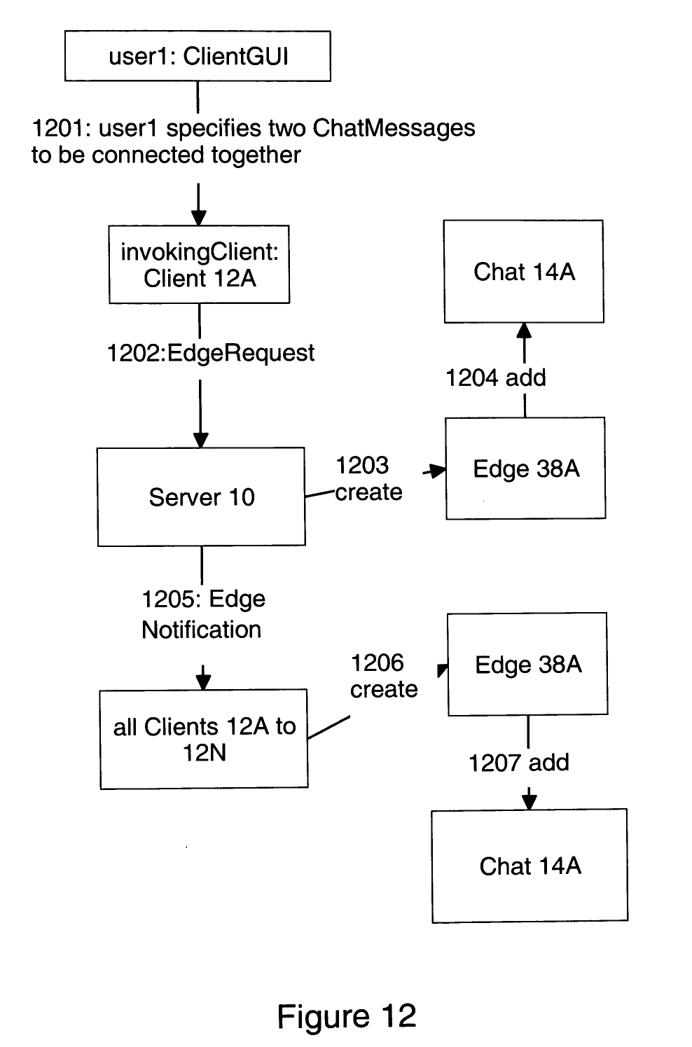

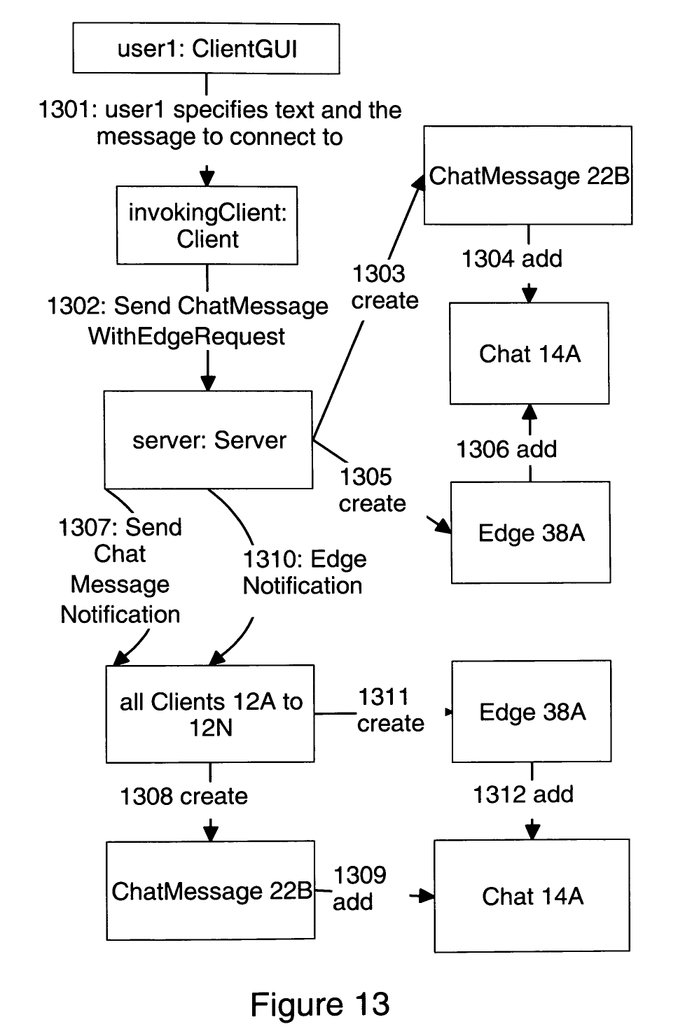

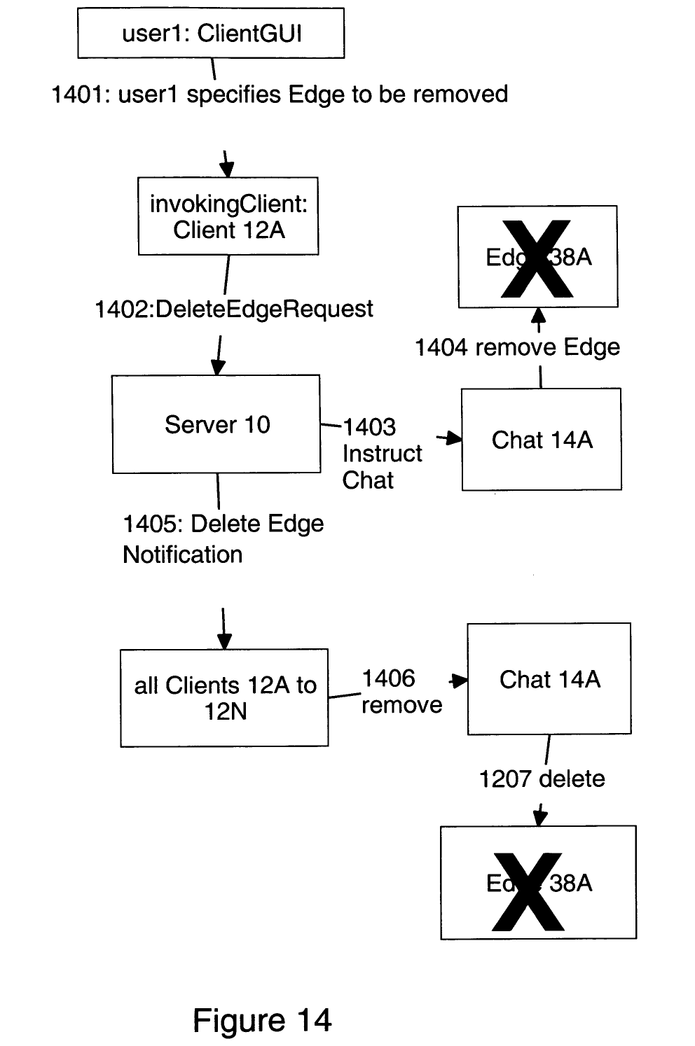

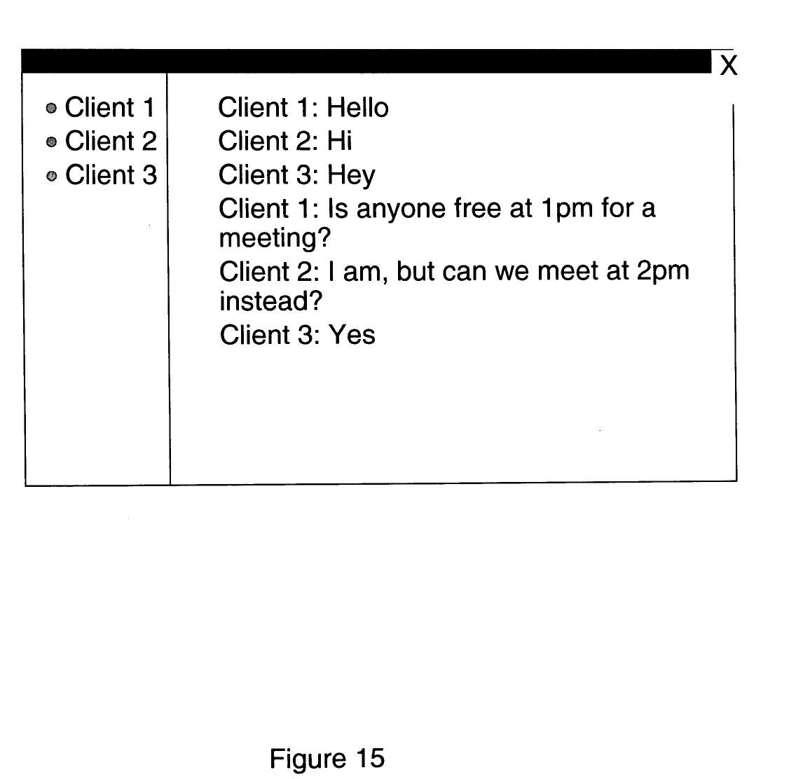

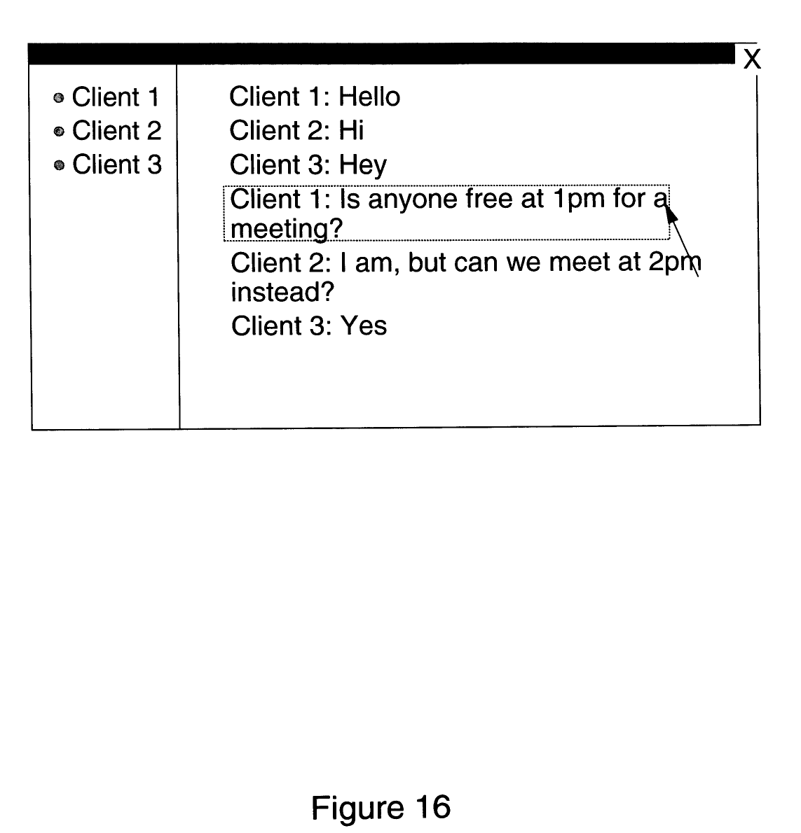

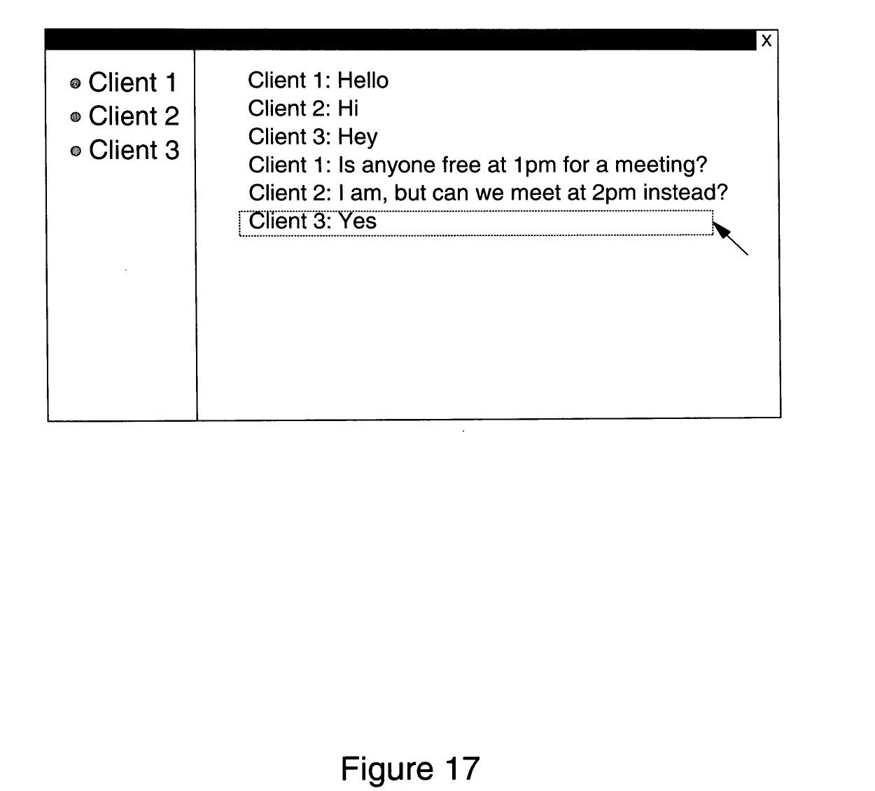

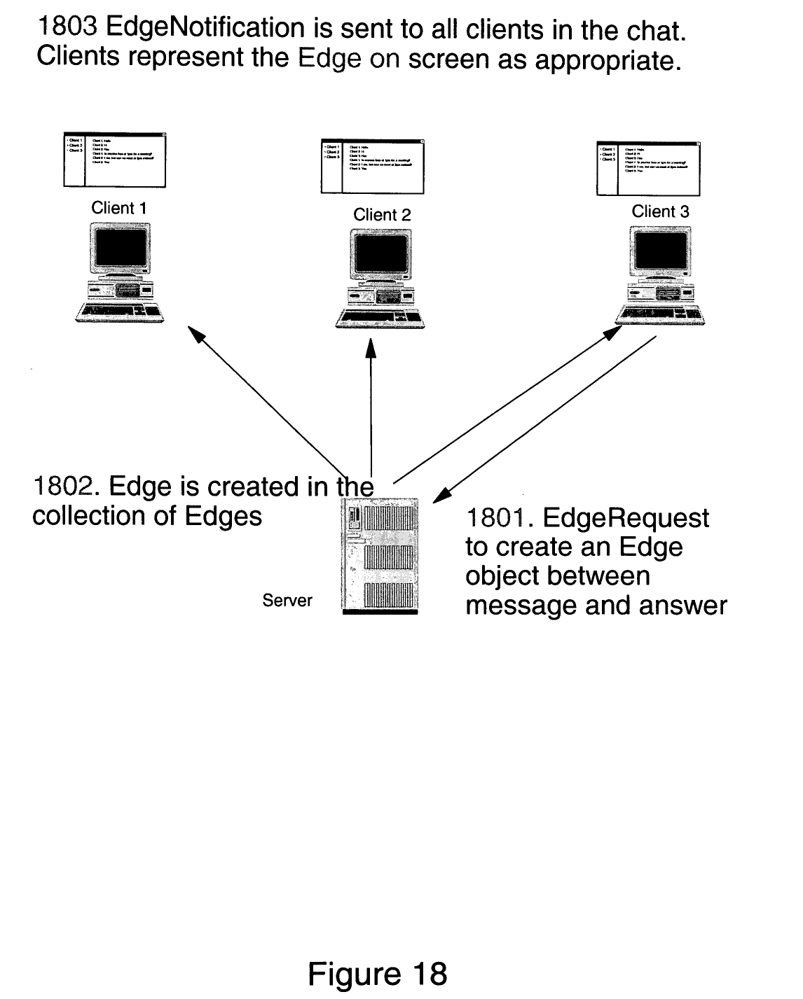

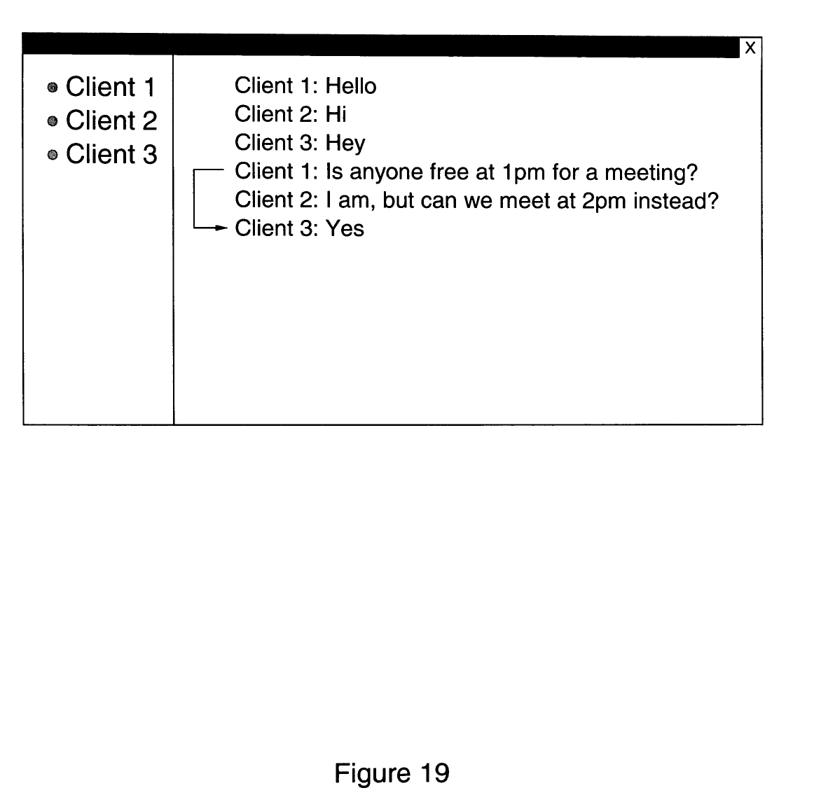

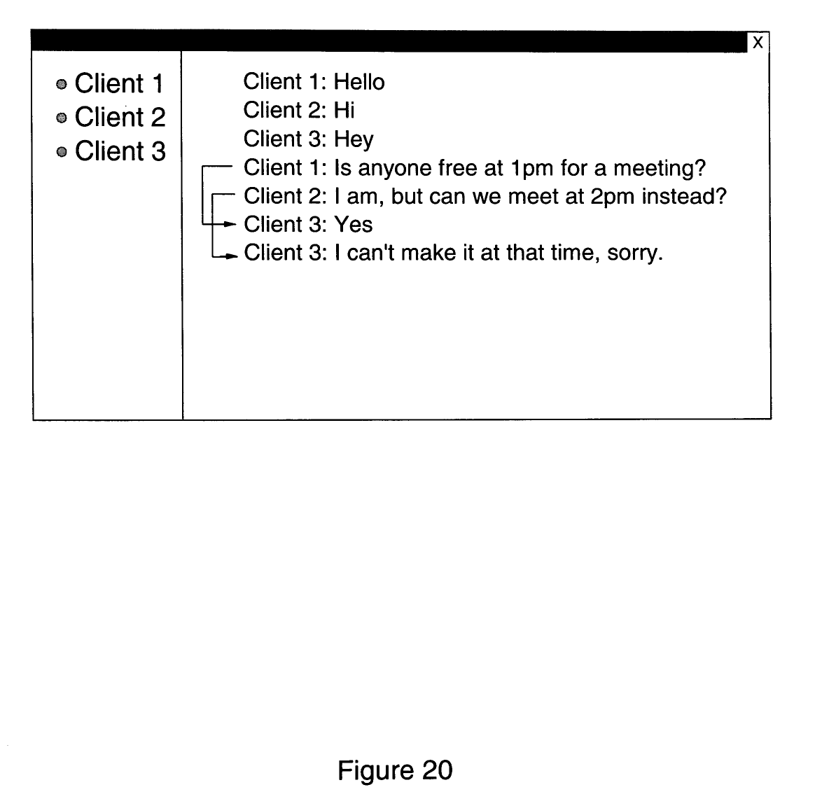

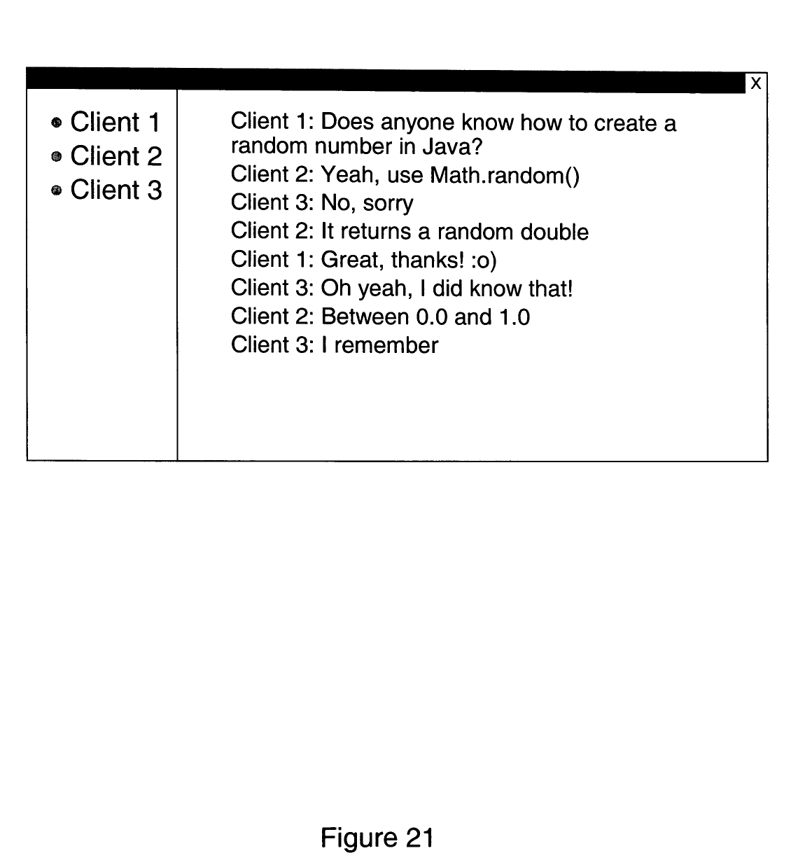

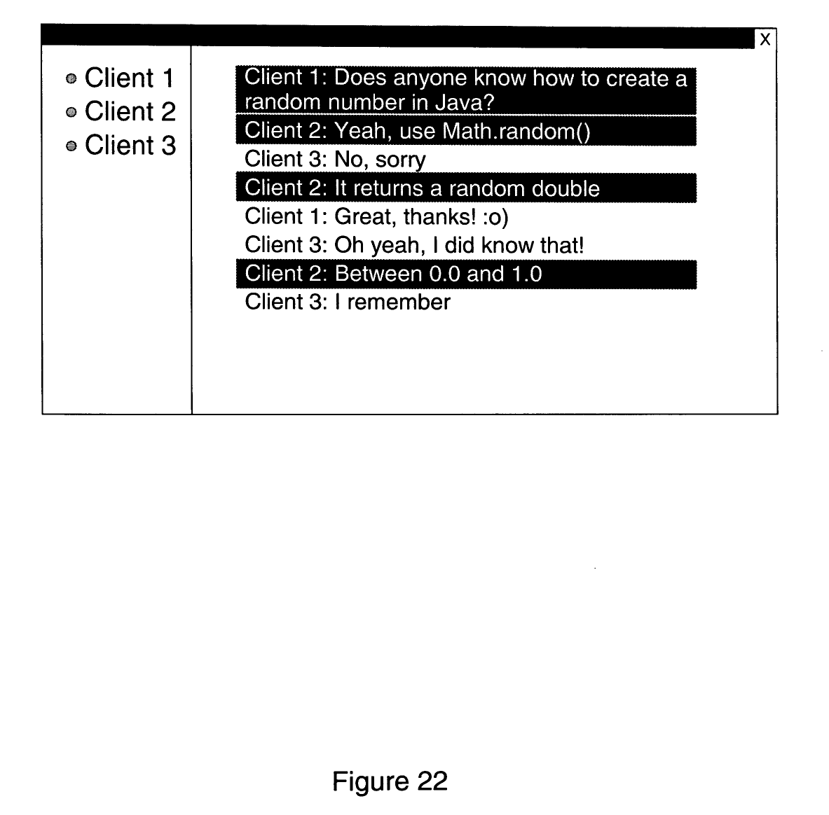

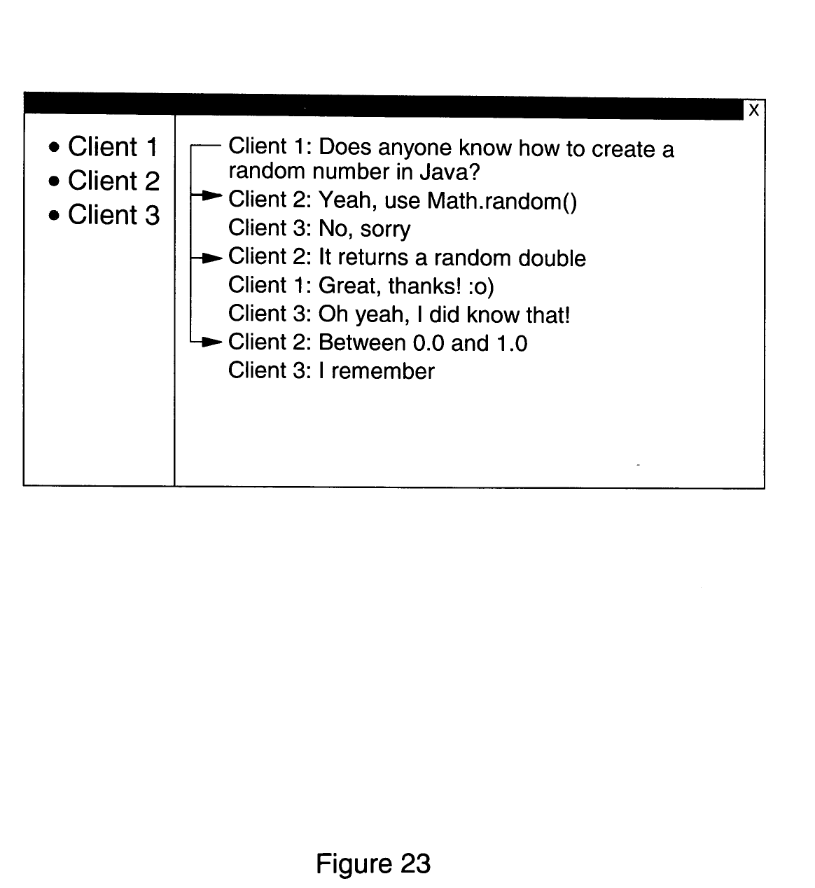

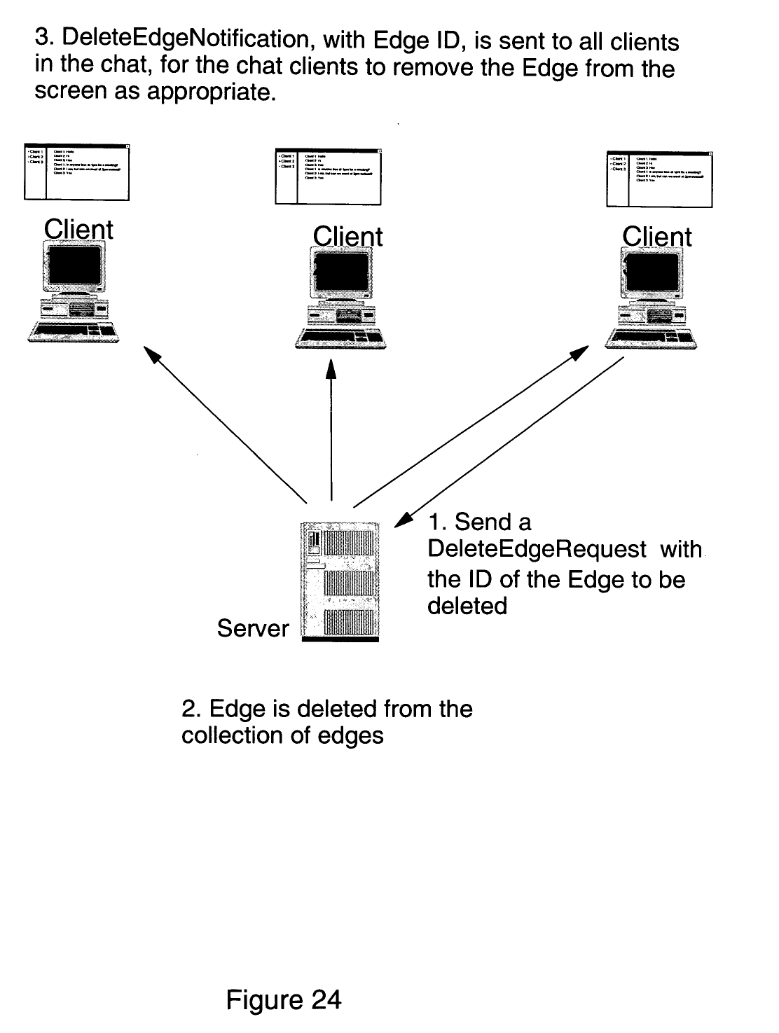

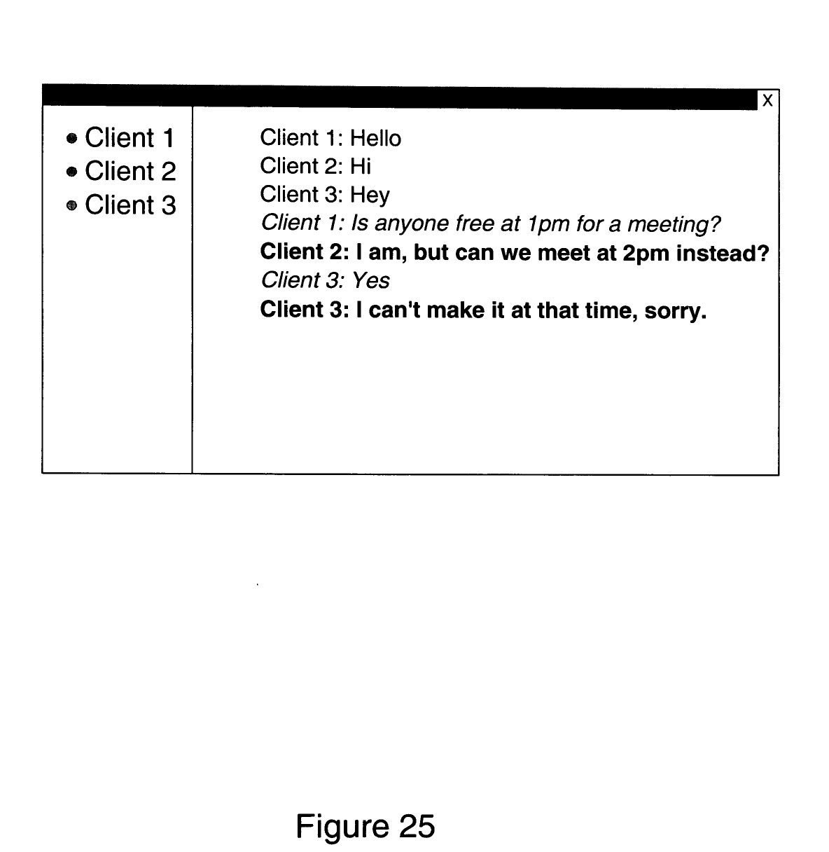

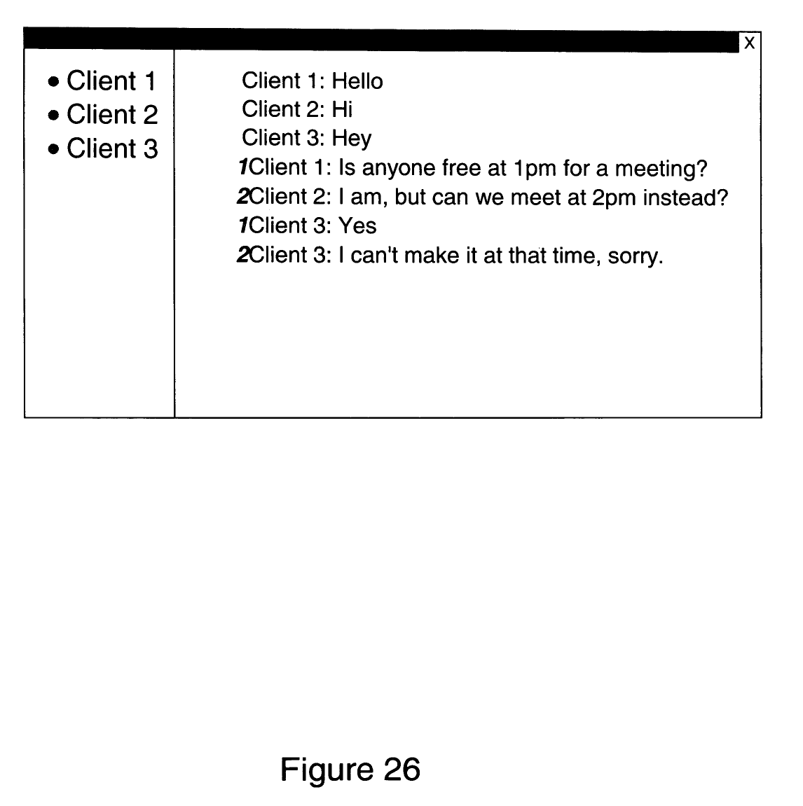

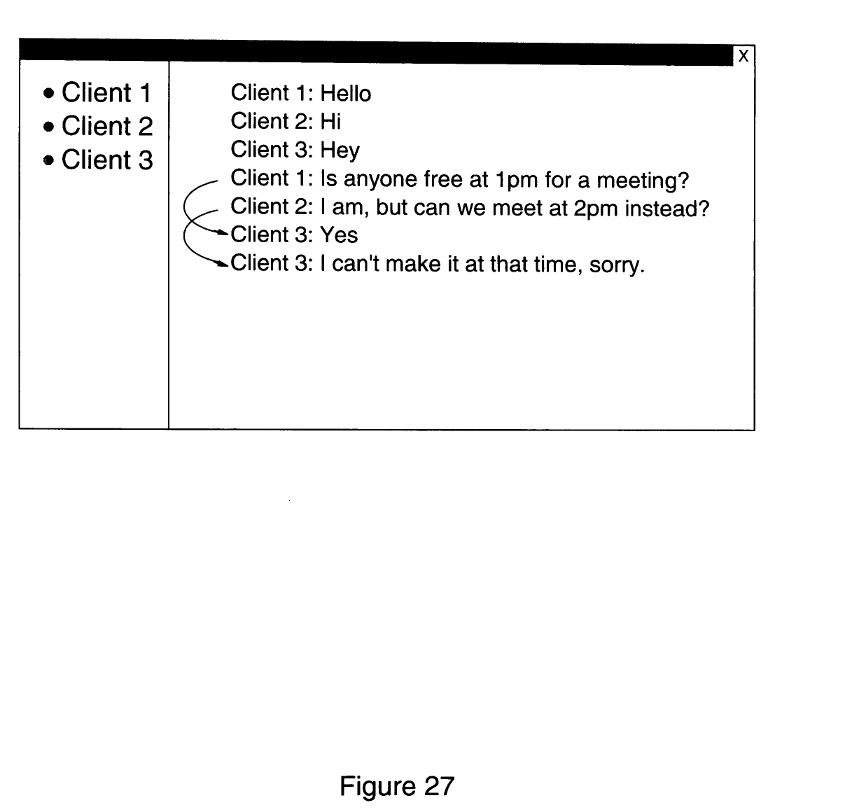

FIG. 7 shows a conversation window with undirected edges and where all messages referenced from Client2's message are selected (highlighted in italic);

FIG. 84 shows a conversation window with directed edges and where only the message directly referenced from Client2's message is selected (highlighted in italic);

FIG. 9 shows a high level overview of the objects of embodiment;

FIG. 10 shows a chat object of FIG. 9 and related objects;

FIG. 11 shows the objects of FIG. 10 with Edges;

FIG. 12 shows the steps in creating an Edge;

FIG. 13 shows sending a ChatMessage in a chat with an Edge attached;

FIG. 14 shows the steps of deleting an Edge;

FIG. 15 shows a current conversation window;

FIG. 16 shows a cursor selecting a first message in the window of FIG. 15;

FIG. 17 shows the cursor of FIG. 16 moved onto a second message;

FIG. 18 shows steps in creating an Edge from a system perspective;

FIG. 19 shows a conversation window of a Chat 14 with an Edge;

FIG. 20 shows the conversation window of FIG. 19 with a further Edge;

FIG. 21 shows the status of a chat on client screens;

FIG. 22 shows the chat of FIG. 21 with related information selected;

FIG. 23 shows the selected information of FIG. 22 with Edges;

FIG. 24 shows the steps and event flow for deletion of an edge;

FIG. 25 shows font formatting used to represent edge linked messages;

FIG. 26 shows numbers used to represent edge linked messages; and

FIG. 27 shows curved arrows used to represent edges.

### DESCRIPTION OF THE ILLUSTRATIVE EMBODIMENTS

A preferred embodiment of the invention is described with respect to FIG. 9. The preferred embodiment comprises: a Server 10; Client 12; and respective chat objects (Chat 14A to Chat 14N). The Server 10 exists on a server computer 16 and communicates with Clients 12 (only one is shown in FIG. 9) on respective remote user computers 18A to 18M over a network. All communication goes through the Server 10 and it is through the Server 10 that Chats are created and managed. The Server 10 maintains a collection of Chats and holds the definitive version of every Chat 14. On a user computer 18A, a Client 12 exposes a graphical user interface (GUI) to the user through which an instant messaging dialogue can be conducted. Similar to the Server 10, each Client 12 maintains a collection of one or more Chats corresponding to the set of instant messaging dialogues that the user is engaged in. Each Chat 14A to Chat 14N that is maintained by a Client 12 is a copy of a Chat 14A to Chat 14N maintained by the Server 10. A Chat 14 is updated to keep it synchronized with the corresponding copy held by the Server 10; a Server 10 will inform respective Client 12s when changes are made to the chat objects maintained by the Server 10.

The client-server embodiment is just one possibility. In a peer-to-peer embodiment a problem of contention would exist so that if two Clients 12 try to send a message at roughly the same time, the system as a whole must make a decision as to which was sent first (since messages are displayed to the user in time-order). A client-server embodiment is preferred as this decision is made by the server.

FIG. 10 illustrates a Chat 14 with associated user objects (User 20A to User 200) and associated ChatMessage objects (ChatMessage 22A to ChatMessage 22P). A Chat 14 comprises a uniqueChatID 19 attribute. The uniqueChatID 19 identifies the Chat 14 uniquely throughout the system and is used by other objects to refer to the Chat 14. Each of User 20A to User 200 represents an actual user who is currently participating in the chat. Each of User 20A to User 200 has UniqueUserID (24A to 240) attribute and Name (26A to 260) attribute. The UniqueUserID 24A is a unique id by which the user is identified throughout the system and used by other objects to refer to the user. The Name 26A attribute is the name of the user as it is displayed to other users in chats.

ChatMessage 22A represents a single message in the chat, the message may be a single line of the dialogue, each line being separated by the carriage return. A definitive copy of a Chat 14A is kept by the Server 10, only the definitive copy is manipulated in response to requests made by the Clients. Any changes made to this definitive copy are then replicated on the local copies of that Chat 14A on the Client 12s. Each Chat 14A will have a sequence of ChatMessages 22A to 22P. A new ChatMessage 22A is created by the Chat 14 when a user types text into a text entry box on the GUI and sends it. ChatMessage 22A comprises the following attributes: uniqueMessageID 30A; text 32A; timestamp 34A; and userID 36A. ChatMessages 22B to 22P have corresponding attributes.

The uniqueMessageID 30A is a unique id by which the ChatMessage 22A is identified throughout the system. The uniqueMessageID 30A is used by other objects to refer to the ChatMessage 22A. The text 32A of the ChatMessage 22A is the text that the user typed into the text entry box on the GUI. The timestamp 34A is the time at which the ChatMessage 22A was created on the Server 10. The ChatMessages 22A to 22P on the Server 10 are stored in order of ascending timestamps 34A to 34P. The userID 36A is the unique ID of the User 20A responsible for creating the ChatMessage 22A.

FIG. 11 is an extension of FIG. 10. It extends the ChatMessages 22A to 22P to include a collection of Edges 38A to 38Q. An Edge is defined by two or more ChatMessages 22A to 22P and the type of graphical link used to join them. A user can create an Edge 38A to indicate a relationship between two ChatMessages 22A, 22B, such a relationship may not be clear from the original positions of the two ChatMessages as displayed in the GUI. For example, if two yes/no questions are asked by different users and a third user subsequently answers “Yes” then an Edge can be created by the third user to indicate which question they are answering. In the preferred embodiment, an Edge links two ChatMessages. However, an Edge can be extended so that it refers to another Edge or refers to more than two ChatMessages.

An Edge 38A comprises the following attributes: uniqueEdgeID 40A; firstMessageID 42A; secondMessageID 44A; and edgeType 46A. Edges 38B to 38Q have corresponding attributes.

If referring to another Edge 38Q then Edge 38A further comprises an edgename attribute (not shown). If an Edge can refer to more than two ChatMessages then an Edge contains a collection (for example, an array or vector) of message ids.

The uniqueEdgeID 40A is a unique id by which the Edge 38A is identified throughout the system; it is used by other objects to refer to the Edge 38A. The firstMessageID 42A refers to the ChatMessage 22A from which this Edge 38A is associated. The secondMessageID 44A references the ChatMessage 22P to which this Edge points. The edgeType 46A attribute defines whether the Edge 38A is directional or non-directional.

An Edge, like a ChatMessage and User, is associated with a particular Chat. Thus, with each Chat, there exists a copy of every Edge in that Chat 14 and a copy of every ChatMessage in that Chat. The definitive copy of any Edge object or ChatMessage object exists with the Server 10. If Client 12A has an associated copy of a Chat 14A then the Client 12A must hold a copy of every Edge and a copy of every ChatMessage too.

The preferred embodiment implements the known operations of a real time chat system: connecting to the Server 10 and logging on; disconnecting from the Server 10; creating Chats 14A to 14N; inviting other users to join Chats; accepting an invite into a Chat; sending messages when in a Chat; and leaving a Chat. The preferred embodiment defines additional operations: creating an Edge 38A in a Chat 14A; sending a message to a Chat 14A with an Edge attached; and deleting an Edge.

FIG. 12 describes the steps by which an Edge 38A is created in a chat:
Step 1201. User1 uses the Client 12A GUI to specify two ChatMessages 22A, 22B that are to be connected together by an Edge38A. The GUI mechanism by which this is accomplished is not discussed in this section;
Step 1202. The invoking Client 12A sends an EdgeRequest message to the Server 10. This message specifies the ID of Chat 14A and the message IDs of the two ChatMessages 22A and 22B that are to be connected together;
Step 1203. The Server 10 creates an Edge 38A that contains the uniqueMessageIds of the two specified ChatMessages;
Step 1204. The Server 10 associates Edge 38A to the specified Chat 14A;
Step 1205. The Server 10 broadcasts an EdgeNotification to all Clients 12A to 12N in the Chat 14A (including the one that sent the EdgeRequest). The EdgeNotification contains the attributes of the Edge 38A;
Step 1206. Each Client 12 that receives this EdgeNotification creates a local copy of the Edge38A; and
Step 1207. Each Client 12 then adds this newly created local copy of the Edge 38A to its own local copy of the Chat 14A.

FIG. 13 describes the steps by which a new ChatMessage 22B is created by a Client 12A along with an Edge 38A that links that ChatMessage 22B to another (pre-existing) ChatMessage 22A.
Step 1301. User1 specifies a) the text of the new message and b) the pre-existing message that the new message is to be connected to. The GUI mechanism by which this is accomplished is not discussed;
Step 1302. Client 12A sends a ChatMessageWithEdgeRequest message to the Server 10. This message specifies the uniqueChatID 19 of the Chat 14A, the text of the new ChatMessage 22B and the ID of the pre-existing ChatMessage 22A to which the new ChatMessage 22B is to be connected by an Edge 38A;
Step 1303. The Server 10 creates a new ChatMessage 22B with the specified text;
Step 1304. The newly created ChatMessage 22B is associated with the Server 10's copy of Chat 14A;
Step 1305. The Server 10 also creates a new Edge 38A that connects the specified pre-existing ChatMessage 22A and the newly creates ChatMessage 22B;
Step 1306. The newly created Edge 38A is added to the Server 10's copy of Chat 14A.
Step 1307. The Server 10 also sends a ChatMessageNotification message to every Client 12A to Client 12N in the Chat 14A, note Client 12A is included. This message specifies sufficient information to completely describe the ChatMessage.
Step 1308. Each Client 12A to Client 12N that receives the ChatMessageNotification creates a local copy of the new ChatMessage 22B.
Step 1309. Each Client 12 adds the newly created local copy of the ChatMessage 22B to its own local copy of the Chat.
Step 1310. The Server 10 broadcasts an EdgeNotification message to Clients 12 in the Chat 14A (including the one that sent the ChatMessageWithEdgeRequest). The EdgeNotification message contains sufficient information to describe the Edge 38A.
Step 1311. Each Client 12A to Client 12N that receives this EdgeNotification message creates a local copy of the Edge 38A.
Step 1312. Each Client 12 then associates this newly created local copy of the Edge 38A with its own local copy of Chat 14A.

FIG. 14 describes the steps by which an Edge is deleted by the embodiment:
Step 1401. User1 uses Client 12A GUI to specify an existing Edge 38A in Chat 14A that is to be deleted. The GUI mechanism by which this is done is not discussed;
Step 1402. The Client 12A sends a DeleteEdgeRequest message to the Server 10. This message specifies the ID of the Chat 14A and the ID of the Edge 38A that is to be deleted;
Step 1403. The Server 10 instructs the Chat 14A to delete the associated Edge 38A;
Step 1404. The Chat 14A deletes the Edge 38A;
Step 1405. The Server 10 broadcasts a DeleteEdgeNotification message to all Clients 12 in the chat (including the one that send the DeleteEdgeRequest message). The DeleteEdgeNotification message contains the ID of the Edge 38A;
Step 1406. Each Client 12A to 12N that receives this DeleteEdgeNotification message instructs its associated local Chat 14A to remove the respective Edge 38A; and
Step 1407. Each Chat 14A then deletes its respective Edge 38A.

In the following examples, Edges are represented graphically as arrows between related messages. Other possibilities for this are described later, such as using a different colour text to represent the related messages.

The Chat 14A window of FIG. 15 is displayed on the screens of all Clients (Client 1, Client 2 and Client 3 corresponding to Client 12A, Client 12B and Client 12C) participating in the current Chat. There are two questions in the chat, asked by Client 1 and Client 2, which result in the answer from Client 3 being ambiguous. It is unclear whether he has answered that he is free at 1 pm or whether he is free to meet at 2 pm instead. This scenario often emerges when the question from one user (Client 2) is entered into the Chat 14A while the other user (Client 3) is in the middle of typing an answer to an earlier question. This ambiguity can be resolved by Client 3 creating an Edge 38A between one of the questions and their answer, thereby indicating which question they are answering. This could be done by Client 3 selecting the question they have answered and ‘dragging’ the question onto the answer as shown in FIG. 16 and FIG. 17. The system then knows to create an Edge 38A between that question and answer.

FIG. 16 shows the cursor over first message which the Edge 38A is to reference after a respective movement of the mouse pointer. The user presses and holds down the left mouse button so that the first message moves with the mouse pointer and the first message is moved over the second message. FIG. 17 shows the cursor after being moved from the first message onto the second message that the Edge 38A is to reference. The left mouse button is then released.

FIG. 18 shows how this edge creation occurs in the overall system.

The edge can now be represented accordingly on the chat clients (in these examples, edges are being represented graphically as arrows between messages).
Step 1801. An EdgeRequest is sent to create an Edge 38A between message and answer
Step 1802. An Edge 38A is created in the collection of Edges
Step 1803. An EdgeNotification is sent to all clients in the chat.

FIG. 19 shows the new status of the chat, the Edge indicating which question Client 3 was answering. Client 3 can then continue the conversation as normal, or alternatively use the Edge facility to answer the other question, as shown in FIG. 20 where a further edge is created to indicate an answer to Client 2's question.

The linking of more than two messages belonging to a certain topic within a conversation is now described with reference to FIGS. 21 to 23. If a Chat 14A contains interspersed messages from several different topics within one conversation, Edges can be used to highlight all messages relating to one topic of the conversation, which could then be saved separately to the rest of the conversation. FIG. 21 shows a typical chat screen with multiple messages. Client 1 wants to save selected messages in this conversation. Edges can be used to link the useful parts of the conversation. This could be done by selecting multiple ‘useful’ parts of the message, typically this may be done by holding down the CTRL key as one selects messages with the mouse cursor. Once all the required messages are selected then the user can execute the operation to add Edges to all the selected messages, see FIG. 22. The outcome of this operation is shown in FIG. 23.

The selected messages can then be saved separately to the remaining messages within the rest of the chat. Any client in the chat can simply highlight the original question and elect to ‘save related messages’ or something similar. The question, along with all messages linked (either directly or indirectly) to that question will be saved. A client wishing to save the chat doesn't necessarily need to select the first message in the chain of related messages. If they only need the information starting from a certain point in the conversation, they can simply highlight their desired chosen message in the chain and select ‘save related messages’. Depending on the direction of the Edges, this will only save the messages from that point, and all messages directly or indirectly linked from this message (i.e. it will not follow Edges backwards).

An edge can be deleted simply by selecting the edge on screen and pressing the delete key (or selecting ‘Delete’ from a menu on the client GUI). FIG. 24 describes the steps involved in a deletion of an Edge.
Step 2401. Send a DeleteEdgeRequest with the ID of the Edge to be deleted from a Client 12 to the Server 10;
Step 2402. The Server 10 deletes the Edge from the collection of Edges; and
Step 2403. a DeleteEdgeNotification, with Edge ID, is sent from the Server 10 to all Client 12s in the chat, and the Client 12s to remove the Edge from their respective copies of the Chat 14 and from the screen as appropriate.

Instead of Edges being represented on the client GUIs using arrows as shown in the previous Figures, there are several other possibilities. Approaches include using a different colour to other messages (not shown); to use different font formatting for Edge-linked messages (FIG. 25); using numbers to reference related messages (FIG. 26); and using curved arrows instead of straight-edged arrows (FIG. 27).

1. A method in an instant messaging system, said instant messaging system having a graphical user interface, said method comprising:
determining a selection of two or more instant messaging entities in the instant messaging system;
creating, on an instruction from the GUI, a relationship between the selected instant messaging entities; and
indicating, using the GUI, the relationship between the instant messaging entities.

2. A method as in claim 1, wherein the instant messaging entities are existing messages or existing relationships between the messages.

3. A method as in claim 1, wherein the created relationship is a simple link or is a dependent link having a direction.

4. A method as in claim 1, further comprising selecting, on an instruction via the GUI, all instant messaging entities having a relationship with a one instant messaging entity.

5. A method as in claim 4, further comprising printing, storing, or deleting the selected instant messaging entities.

6. An instant messaging system comprising:
a graphical user interface;
a means for determining a selection of two or more instant messaging entities in the instant messaging system;
means for creating, on an instruction from the GUI, a relationship between the selected instant messaging entities; and
means for indicating, using the GUI, the relationship between the instant messaging entities.

7. An instant messaging system as in claim 6 wherein the instant messaging entities are existing messages or existing relationships between the messages.

8. An instant messaging system as in claim 6, wherein the created relationship is a simple link or is a dependent link having a direction.

9. An instant messaging system as in claim 6, further comprising means for selecting, on an instruction via the GUI, all instant messaging entities having a relationship with a one instant messaging entity.

10. An instant messaging system as in claim 9, further comprising means for printing, means for storing, or means for deleting the selected instant messaging entities.

11. An instant messaging client comprising:
a graphical user interface;
a means for determining a selection of two or more instant messaging entities in the instant messaging system;
means for creating, on an instruction from the GUI, a relationship between the selected instant messaging entities; and
means for indicating, using the GUI, the relationship between the instant messaging entities.

12. An instant messaging client as in claim 11, wherein the instant messaging entities are existing messages or existing relationships between the messages.

13. An instant messaging system as in claim 11, further comprising means for selecting, on an instruction via the GUI, all instant messaging entities having a relationship with a one instant messaging entity.

14. An instant messaging system as in claim 13, further comprising means for printing, means for storing, or means for deleting the selected instant messaging entities.

15. A computer program product for an instant messaging system, said computer program product comprising computer program instructions stored on a computer-readable storage medium for, when loaded into a computer and executed, causing a computer to carry out the following steps:
providing a graphical user interface;
determining a selection of two or more instant messaging entities in the instant messaging system;
creating, on an instruction from the GUI, a relationship between the selected instant messaging entities; and
indicating, using the GUI, the relationship between the instant messaging entities.

16. A computer program product as in claim 15, wherein the instant messaging entities are existing messages or existing relationships between the messages.

17. A computer program product as in claim 15, wherein the created relationship is a simple link or is a dependent link having a direction.

18. A computer program product as in claim 15, further comprising selecting, on an instruction via the GUI, all instant messaging entities having a relationship with a one instant messaging entity.

19. A computer program product as in claim 18, further comprising printing, storing, or deleting the selected instant messaging entities.
